(19) United States
(12) Patent Application Publication
(10) Pub. No.: US 2026/0225714 A1
(43) Pub. Date: Aug. 6, 2026

(54) SHORT TAKEOFF AND LANDING AMPHIBIOUS AIRCRAFT

(71) Applicants: Vadim Yurievich TSYBENKO, Guryevsk (RU); Yuri Vladimirovich TSYBENKO, Guryevsk (RU)

(72) Inventors: Vadim Yurievich TSYBENKO, Guryevsk (RU); Yuri Vladimirovich TSYBENKO, Guryevsk (RU)

(21) Appl. No.: 19/151,324

(22) PCT Filed: Feb. 29, 2024
(86) PCT No.: PCT/IB2024/051962

§ 371 Date: Jul. 27, 2025

(30) Foreign Application Priority Data
Mar. 9, 2023 (RU) 2023105407

(51) Int. Cl. B64C 35/00; B64C 7/02; B64C 11/00; B64D 33/10

(52) U.S. Cl. CPC B64C 35/006; B64C 7/02; B64C 11/001; B64C 35/003; B64C 35/008; B64D 33/10

(57) ABSTRACT

The invention relates to aviation, in particular to seaplane designs. The amphibious aircraft comprises a fuselage, floats, a wing with wingtips, an empennage, a propulsor, a power plant, a landing gear, main lift hydrofoils and rear water support, and a water rudder. The floats are connected to the fuselage, the wing and the empennage in the shape of a profiled ring by means of strakes, fairings, as well as longitudinal steps along the bottom. The propeller-type propulsor is integrated into the profiled ring, wherein the profiled ring comprises a high-set elevator with profiled lateral surfaces, as well as lateral rudders. An increase in lift-to-drag ratio and efficiency, short takeoff and landing capability, increased stability and controllability of amphibious aircraft are provided.

### FIELD OF THE INVENTION

The present invention relates to aircraft engineering, in particular to amphibious aircraft.

### BACKGROUND OF THE INVENTION

A Lisa Akoya amphibious aircraft (Jane's All the World's Aircraft 2011-12, pp. 207-208, ISBN 978-0-7106-2955-5) comprises a high-set wing with downwardly inclined wingtips and a propeller engine mounted on the aircraft fin; a three-point hydrodynamic mode configuration with main front hydrofoils and a rear hydrofoil is implemented in the aircraft.

The disadvantage of the prior art solution is a significant adverse interference drag at the junction of engine nacelle, the fin and the tailplane, and a turbulent flow along said elements in the propeller wake, and the prior art solution does not comprise devices for increasing stability in transition to hydrodynamic mode when the three-point configuration is not yet fully operational.

The prior art solution closest to the present invention is an amphibious aircraft disclosed in Russian Federation U.S. Pat. No. 2,028,965, the aircraft comprising a fuselage, a center section, wings, a power plant, an empennage, and a landing gear with control mechanisms, wherein the fuselage is formed by a low aspect ratio wing, the aircraft characterized in that the aircraft is equipped with pylons located on the sides of the center section and along its axis of symmetry.

The disadvantage of the prior art solution is that it does not provide effective control of the air flow using external rudders when a wide center section is used, which can create a flow separation at high angles of attack, no solutions are provided for reducing interference drag between the wing, fuselage and empennage, and no solutions are provided for reducing wetted area of a wide bottom in transition to hydrodynamic mode.

### SUMMARY OF THE INVENTION

The present invention makes it possible to provide an increase in lift-to-drag ratio and efficiency, short takeoff and landing capability, increased stability and controllability of amphibious aircraft.

The present invention provides an amphibious aircraft comprising a fuselage, floats, a wing with wingtips, an empennage, a propulsor, a power plant, a landing gear, main lift hydrofoils and a rear water support, and a water rudder, the aircraft characterized in that the floats are connected to the fuselage, the wing and the empennage in the shape of a profiled ring by means of strakes, fairings, as well as longitudinal steps along the bottom; wherein the propeller-type propulsor is integrated into the profiled ring; wherein the profiled ring comprises a high-set elevator with profiled lateral surfaces, as well as lateral rudders.

In one potential embodiment, an aircraft is provided wherein the main lift hydrofoils are configured for operating in hydro-ski mode.

In one potential embodiment, an aircraft is provided wherein the rear water support comprises a low-set sliding skid and a rear hydrofoil with the water rudder arranged therebetween.

In one potential embodiment, an aircraft is provided wherein the wing is mid-set.

In one potential embodiment, an aircraft is provided wherein the wingtip is inclined downward and configured to perform the aerodynamic lift function with increased stall resistance, and the float function.

In one potential embodiment, an aircraft is provided wherein the lateral surfaces of the elevator are configured for differential deflection with respect to the central part of the profiled ring, providing a change in the diffuser area ratio of the profiled ring channel.

In one potential embodiment, an aircraft is provided wherein the rudders in the profiled ring are configured for differential deflection, providing a change in the diffuser area ratio of the profiled ring channel.

In one potential embodiment, an aircraft is provided wherein the elevator and the rudder in the profiled ring are slotted.

In one potential embodiment, the aircraft comprises bent plates and cutouts on the root portion of the hydrofoils allowing for passive stabilization of the hydrofoils.

In one potential embodiment, the aircraft comprises bent plates and longitudinal steps on the lower surface of the integrated floats allowing to cut off water flows spreading across the aircraft bottom.

In one potential embodiment, the aircraft comprises hydro-ski having a flattened lower portion and an increased span allowing for takeoff and landing on snow.

In one potential embodiment, the aircraft comprises a smooth cut of the rear contour of the profiled ring in the lower portion thereof allowing to reduce drag.

In one potential embodiment, the aircraft comprises rotary plates integrated into the lower portion of the profiled ring and configured for changing the diffuser area ratio of the ring and protecting the propeller from rear waves.

In one potential embodiment, an aircraft is provided wherein the propeller propulsor thereof comprises a nacelle integrated into the rear portion of the fuselage with smooth fairing transitions.

In one potential embodiment, an aircraft is provided wherein smooth fairing transitions are arranged between the profiled lateral portions of the elevator and the profiled ring.

In one potential embodiment, the aircraft is configured for bleeding air through the fuselage tip with integrated radiators for cooling the power plant to provide boundary layer suction in the narrowing area of the fuselage at the rear portion thereof and at the areas of transition to the lateral float.

In one potential embodiment, the aircraft utilizes high lift devices formed by slats and flaps.

The object of increasing lift-to-drag ratio and efficiency is achieved by using hydrofoils and an integral aerodynamic configuration wherein the lateral floats are connected to the fuselage, the wing and the empennage in the shape of a profiled ring by means of strakes, fairings, as well as longitudinal steps along the bottom, while the elevator, the rudder and the propeller propulsor are integrated into the profiled ring. The claimed result is achieved by reducing adverse interference drag between the fuselage, the wing and the empennage, as well as by reducing the aerodynamic area at a set internal volume, which, along with the use of hydrofoils, leads to an increase in lift-to-drag ratio. Furthermore, the propeller wake affects only the rear inner portion of the ring, thus allowing to provide a laminar flow on most of the aircraft surface ahead of the propeller propulsor, including on most of the empennage. In addition to an increase in lift-to-drag ratio, the increase in efficiency is further enhanced due to the lower power demand of the power plant due to the use of a propeller propulsor in the ring, thus providing a required power reduction at a set thrust.

An embodiment is contemplated wherein the integral aerodynamic configuration is expanded to include the wingtip providing the float function, such that the wingtip is integrated into the wing by means of a strake and has a small downward inclination without a protruding float portion; the minimum adverse interference drag is provided due to the relatively small angle of the inclination and the lack of a separate bend in the immersed part while maintaining the pressure under the wing and reducing induced drag. When using a mid-set wing, the best aerodynamic integration of the profiled ring into the aircraft layout and the best conditions for reducing adverse interference drag are achieved. In embodiments with differential deflection of the elevator and the rudder, the propeller propulsor in the ring adapts to different flight modes by changing the diffuser area ratio to maximize its efficiency. An embodiment is contemplated with boundary layer suction in the fuselage narrowing section transitioning to the float, wherein air passes within the fuselage through power plant cooling, allowing to increase the efficiency of the propeller propulsor by retaining the flow on the surfaces in front of it and restoring suction losses due to heating from the power plant. An embodiment is contemplated with a smooth cut of the rear contour of the profiled ring in the lower portion thereof to reduce drag.

The object of achieving short takeoff and landing capability is achieved by using hydrofoils, longitudinal steps along the bottom at the transition from the integrated floats to the fuselage, and a propeller propulsor in a profiled ring, as well as due to the integral aerodynamic configuration. Hydrofoils facilitate rapid transition to the hydrodynamic mode. The transition to the hydrodynamic mode is facilitated due to greater propeller thrust in the profiled ring; acceleration time is also reduced due to greater thrust at set power. Due to intensive air movement over the integrated floats, the fuselage and the root portion of the wing, which is achieved by propulsor operation, an additional lifting force is achieved over said parts of the aircraft, further contributing to takeoff shortening. The use of longitudinal steps at the joint between the fuselage and the floats allows to cut off water flows spreading across the bottom, which is especially important when using an integrated profiled ring which causes a widening of the bottom in the rear of the aircraft, which is the area the most susceptible to the sticking effect (caused by a large surface wetted with water) at the transition to the high-speed hydrodynamic mode.

An embodiment is contemplated wherein the hydrofoils perform a hydro-ski function when entering the hydrodynamic mode, allowing to reduce spray formation and therefore the associated drag, reduce energy costs for takeoff and thereby reduce takeoff distance. In the embodiment with additional water-reflecting plates or longitudinal steps, water flows from the root of the wing are further cut off on the lower surface of the floats to reduce undesirable wetting in the transition to hydrodynamic mode. In the embodiment wherein the rear water support is separated into the rear hydrofoil and the lower planing support, spray formation in the hydrodynamic mode can further be reduced; this provides easy separation from the water and quick transition to said mode due to the backwards-offset hydrofoil, providing maximum moment of force in said position. In the embodiment with a mid-set wing, the aircraft properties concerning separation from water can be improved. In the embodiment with an integrated inclined wingtip, increased air pressure can be maintained under the wing near the ground surface, allowing to reduce takeoff and landing speed.

The object of increasing stability and controllability in hydrodynamic mode is achieved by using longitudinal steps at the bottom joint between the integrated floats and the bottom along with a three-point configuration with hydrofoils and a rear water support. In transition flight modes, the longitudinal steps contribute to roll stability until the three-point hydrodynamic configuration enters operation.

In the embodiment with combined hydrofoils providing the hydro-ski function, stability can be increased due to the greater intrinsic stability of the hydro-ski. In the embodiment comprising a low-set rear planing support, a rear hydrofoil and a water rudder there between, a smooth stable transition to the hydrodynamic mode is provided with a limited pitch angle due to the operation of the hydrofoil, while a smooth decrease in the sensitivity of the water rudder when leaving the water is provided. An embodiment of the hydrofoils is contemplated wherein the hydrofoils comprise a passive stabilization system based on bent plates and cutouts on the root portion of the hydrofoils.

The object of increasing stability and controllability in the aerodynamic portion is achieved by the elevator integrated into the profiled ring with profiled lateral surfaces and integrated lateral rudders, as well as by strakes at the transition between the float and the wing. The elevator with profiled lateral surfaces allows to increase the area for longitudinal stabilization of the aircraft and pitch control, which is specifically important for the empennage in the shape of a profiled ring in order to prevent the flow from descending along the sides. The vortex from the strake between the wing and the strake allows to ensure controllability at large angles of attack by establishing continuous flow around the profiled lateral portions of the elevator and the rudder surfaces, which is especially important due to the wide body of the aircraft with integrated lateral floats.

In the embodiment with slotted rudder and elevator having portions bent into the cross-section of the ring, the flow is retained within the profiled ring and on the outer surface of the rudder and elevator, and aerodynamic balance and improved controllability are thus provided. In the embodiment the downwardly inclined integrated wingtip float, a strake is provided at the transition from the main wing portion operating as a vortex generator at high angles of attack, allowing to maintain stability and controllability due to the continuous flow over the wingtip; the downwardly-inclined wingtip further provides better stability in crosswind.

### BRIEF DESCRIPTION OF THE DRAWINGS

FIG. 1 is a diagram of the aircraft according to the invention (isometric view).

FIG. 2 is a diagram of the aircraft illustrating the bottom (isometric view).

FIG. 3 is a diagram of the aircraft illustrating the bottom (enlarged isometric view).

FIG. 4 is a diagram of the bottom with combined hydrofoil/hydro-ski (enlarged isometric view).

FIG. 5 is a diagram of the tail part of the aircraft (side view).

FIG. 6 is a diagram illustrating operation of the lateral rudders in the profiled ring.

FIG. 7 is a diagram illustrating elevator operation.

FIG. 8 is a diagram of boundary layer suction (enlarged isometric view).

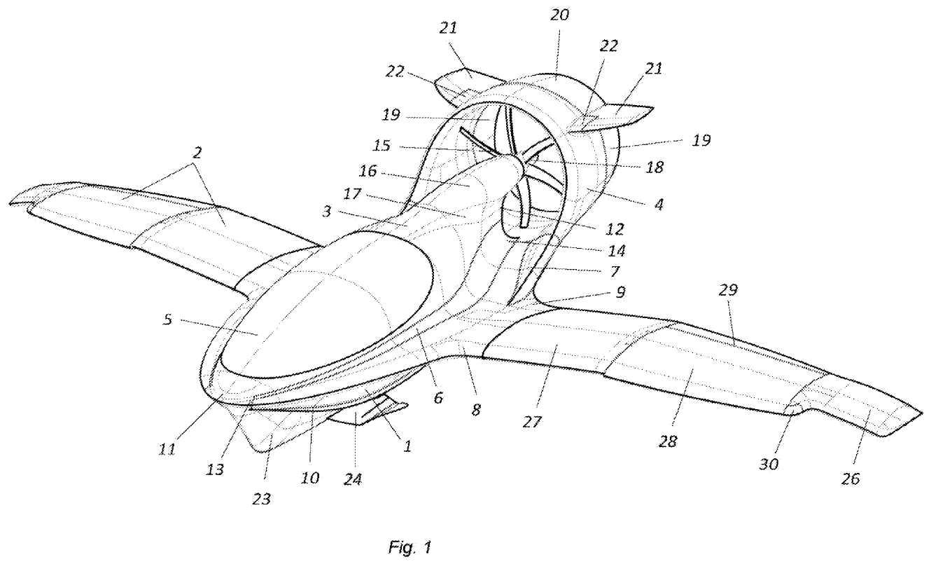

FIG. 1 illustrates an amphibious aircraft with a mid-set wing according to the present invention, wherein the integrated floats (1) provide mating between the mid-set wing (2), the fuselage (3) and the profiled ring (4). The fuselage (3) comprises a cabin (5). A fairing (6) is arranged between the integrated floats and the upper fuselage portion, and a strake with fairings (7) is arranged between the profiled ring (4) and the integrated floats (1). A front transition strake (8) and a fairing with a transition to the trailing edge (9) are arranged between the wing and the float.

The fuselage and floats along the bottom comprise a transition based on longitudinal steps (10). The floats are arranged from the nose of the fuselage (11) to the rear end of the fuselage (12); they are coupled (13) with the nose portion, and the profiled ring is connected to the rear portion of the floats both from above and across the bottom steplessly (14).

An air propeller (15) is arranged within the profiled ring (4), the shaft of the propeller rotating in the rear portion of the fuselage which mostly has the shape of an integrated nacelle (16), preferably smoothly coupled with the fuselage (3) by means of fairings (17). The propeller (15) has a rotating cowl (18) formed by a continuation of the integrated nacelle (16).

Two predominantly slotted rudders (19) are integrated into the profiled ring (4) on the left side and on the right side from the center plane of the aircraft body. The elevator has a main slotted surface (20) and further includes profiled lateral portions (21) outside the profiled ring. Fixed transitional strakes (fairings (22)) are arranged on the outer surface of the profiled ring.

Hydrofoils (24) are attached to the lower portion (23) of the fuselage.

The wing (2) of the amphibious aircraft has wingtips (26) lowered (inclined) downwards. The wing is preferably divided into two sections: the inner section (27) and the outer section (28) along with the wingtip (26) comprising a strake (30). An aileron (29) or any other roll control device, e.g., an interceptor, is arranged on the outboard wing portion.

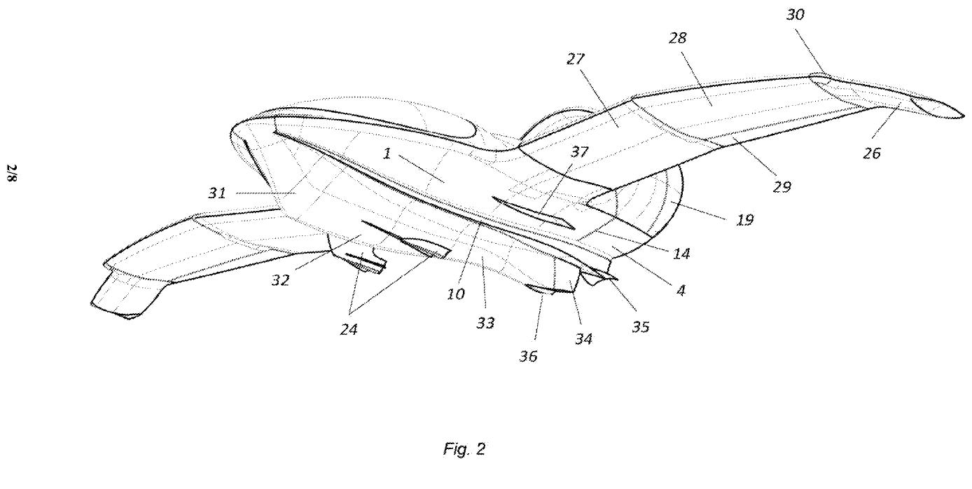

FIG. 2 illustrates a bottom view of the aircraft, the bottom comprising a nose portion (31) which is preferably pointed (wave-piercing); a central portion (32) and a transitional rear portion (33). The rear portion (33) transitions into a water rudder (34). Steps (10) converge towards the tail portion of the aircraft in the bottom area without forming a transom ledge; a rear hydrofoil (35) is arranged in the area where the longitudinal steps converge. A rear planing bumper is provided under the rear portion (33) of the fuselage bottom. Plates or additional longitudinal steps (37) are arranged on the lower surface of the floats.

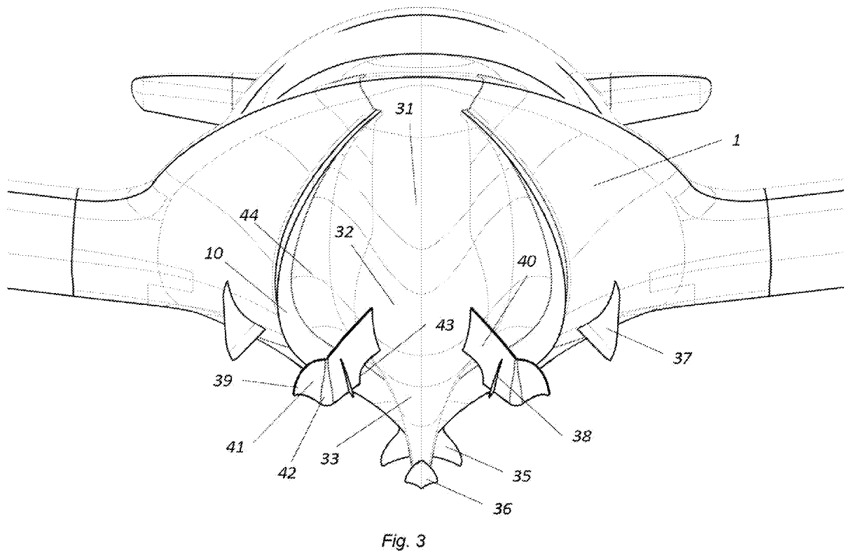

FIG. 3 illustrates longitudinal cutting plates or longitudinal steps (38) and bends (39) on the lateral inner faces (40) and outer faces (41), respectively, in the hydro-ski hydrofoils. The hydro-ski hydrofoils comprise working sliding surfaces (42); cutouts (43) are further provided along the trailing edge. The articulation of the integrated floats (1) along the bottom of the fuselage and, partially, in the tail portion of the aircraft along the lower surface of the profiled ring is provided via the longitudinal steps (10); fairings (44) are used for smooth transition from the fuselage to the steps.

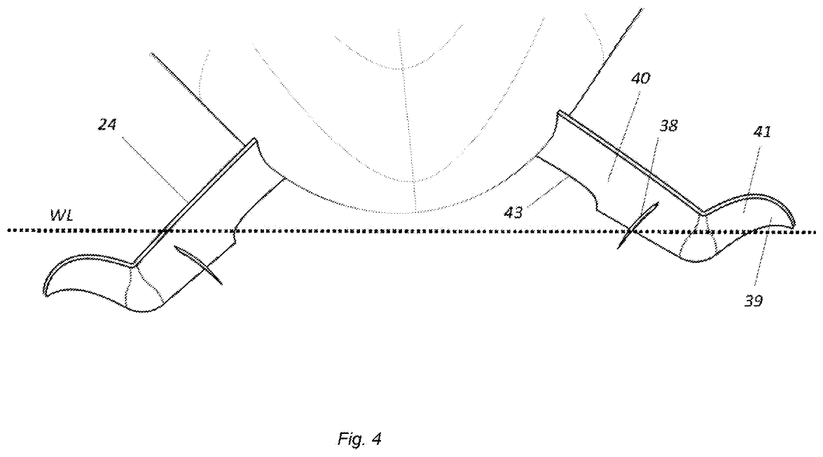

FIG. 4 illustrates stabilization operation of hydro-ski hydrofoils (24) in transition flight mode, and destabilization is shown.

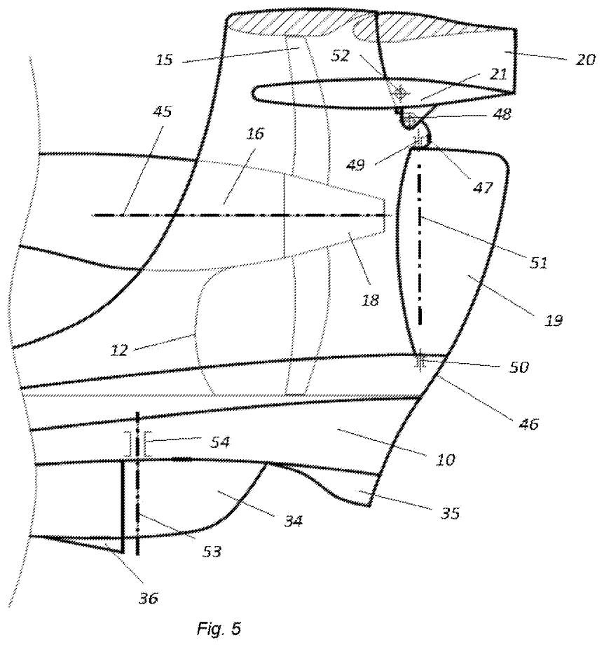

FIG. 5 illustrates the tail portion when viewed from the side with the air propeller (15) on the axis (45), the nacelle (16), the propeller cowl (18), the aerodynamic rudder (19), the main portion of the elevator (20), the profiled lateral surfaces (21), the longitudinal steps (10), the water rudder (34), the rear planing skid (36) and the rear hydrofoil (35). A preferable smooth cut of the contour (46) of the trailing edge of the ring from below is provided. Upper combined assemblies (47) are provided for suspending the main section of the elevator (48) and the aerodynamic rudder (49). Support assemblies (50) for turning the aerodynamic rudder are arranged in the lower portion of the ring, so that the assemblies (49) and (50) are coaxial with a single virtual pivot axis (51). A rotation assembly (52) for the profiled lateral surfaces (21) is further provided. Further shown are the water rudder axis (53) and the assembly for turning the water rudder within the fuselage (54).

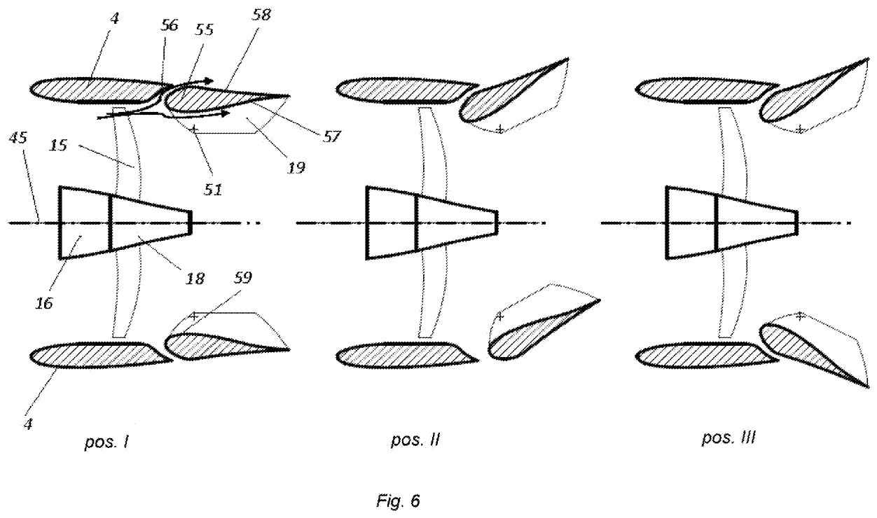

FIG. 6 illustrates a diagram of operation of the slotted aerodynamic rudders (19) integrated into the profiled ring (4), shown in a cross-section passing through the rotational axis (45) of the air propeller (15). Position (I) indicates the neutral position, position (II) indicates a standard turn, position (III) indicates an increase in diffuser area ratio (and potential braking mode). The rudder has an offset virtual pivot axis (51). The toe of the rudder (55) is separated from the profiled ring by a slot (56). The rear part of the skin within and outside the ring (57) comprises concavities (58) on the profile tail. The inner skin (59) is recessed into the ring cross-section to retain the flow when it passes over the slot.

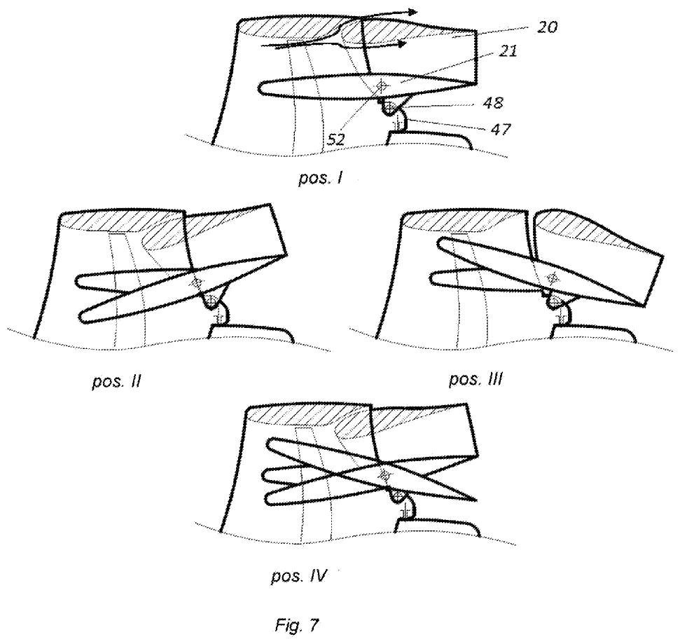

FIG. 7 illustrates operation of the elevators: position I-neutral position; position II position for pitching; position III-position for diving; position IV-differential deflection of the main section of the elevator (20) and the profiled lateral surfaces (21).

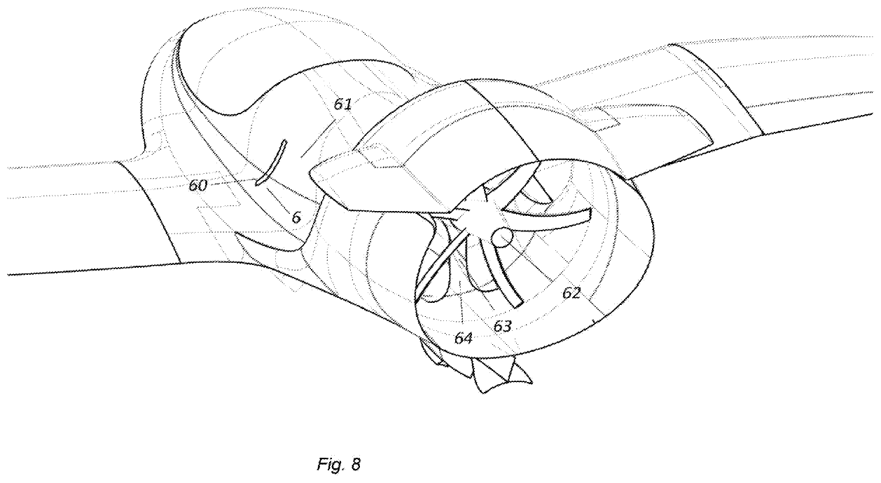

FIG. 8 is a diagram of boundary layer suction at the fuselage narrowing point. For implementing the scheme, slots (60) are used (perforations are also possible) in the area of the wall of the narrowing fuselage portion (61) and the adjacent wall of the fairing (6) which is the transition to the integrated float. Air bleeding is carried out through slots and channels in the rear portion of the fuselage to areas of natural underpressure behind the propeller cowl (62); it is also possible to use a special organized slot (63) at the end of the fuselage; cutoffs in the fairings at the end of the fuselage (64) also constitute a natural outlet.

### DETAILED DESCRIPTION OF THE INVENTION

The matings between the floats (1), the fuselage (3), the profiled ring (4) and the wing (2) are preferably determined by the hydrodynamic and aerodynamic requirements therefore in the integrated aerodynamic configuration of the amphibious aircraft. Longitudinal steps (10) on the bottom between the fuselage and the floats essentially do not degrade the aircraft aerodynamics but cut off lateral water flows when transitioning to the hydrodynamic mode and provide stability in said mode. The fairing transition from the upper portion of the fuselage to the float (6) is smooth, preferably with an increasing radius towards the rear end of the fuselage (12) to reduce stall probability in the fuselage narrowing portion. The floats (1) are preferably integrated along the entire length of the fuselage (3) with a smooth transition (13) to the nose tip (11) thereof for maximum aerodynamic integration. The lateral transitions (7) from the profiled ring (4) to the floats (1) are provided in the form of fin extensions with fairings. The transition (14) from the rear portion of the float (1) to the profiled ring (4) is stepless both on the upper portion of the skin and from the bottom side.

The air propeller (15) rotates in the profiled ring (4), the propeller preferably formed by a multi-blade propeller which allows to achieve efficiency thereof in a wide speed range even with a constant pitch set on the ground (which is important for the LSA class of light aircraft). The air propeller in the ring provides a high thrust-to-power ratio while accelerating the flow above the upper surface of the integrated float (1) and the root of the wing (2). In combination, this allows to achieve improved takeoff and landing properties: reduced takeoff time and length.

The integrated nacelle (16) allows to coordinate maximum fuselage height with the position of the axis line of the profiled ring (4); preferably, fairings (17) are arranged at the transition between the nacelle and the fuselage. The power plant can be arranged in the nacelle, in the rear or center portion of the fuselage behind the cabin (5), and preferably in the front portion of the fuselage, which will ensure the balancing of the light aircraft when the cabin is arranged close to the center of mass. The power plant comprises a shaft connecting the engine to the air propeller shaft. It is preferable to provide a cockpit (5) accommodating the crew or the payload that is fully aerodynamically integrated into the fuselage without ledges and transitions.

The profiled ring (4) is arranged in the rear portion of the aircraft and constitutes a part of the aircraft empennage. The rudders (19) and the center portion of the elevator (20) are integrated into the profiled ring, thus providing minimum interference drag. The lateral surfaces (21) of the rudder are very important in terms of ensuring stability and controllability of the aircraft, especially for light aircraft wherein stabilization systems are not generally used. Profiled lateral surfaces (21) increase the control area and prevent the flow from moving down from the curvilinear surface (20) of the profiled ring. In general, increasing the surface area in the upper portion of the ring allows to increase aircraft stability in the longitudinal direction. This configuration splits the flows along the control surface into the outer flow and the inner flow through the profiled ring, which allows, when selecting the area, to find the optimal ratio of propeller thrust effect during blowing to the outer flow speed; if the propeller is stopped, the shading effect of its blades on aircraft control is reduced; reliable control can be provided at large angles of attack as a portion of the control surface (21) is arranged outside the fuselage shading zone. From a purely aerodynamic standpoint (without stalling phenomena and with minimal interference), this configuration of the elevator and the rudder further allows to integrate the steering surfaces into the ring of the propeller propulsor/empennage using conventional mechanical hinge joints, as will be discussed below. The profiled lateral portions (21) of the elevator are connected to the main portion of the elevator (20), and the connection can be rigid or provided via a hinge joint and the control system; in the latter case, the movement of the main portion (20) and preferably the synchronous movement of the profiled lateral surfaces (21) connected through a differential mechanism provide simultaneous pitch control and diffuser area ratio adjustment of the profiled ring (4) channel. Changing the diffuser area ratio of the profiled ring channel due to differential operation of the elevator and the rudder allows to achieve optimal efficiency at various flight speeds. Fixed transitional strakes on the outer surface of the profiled ring (fairings (22)) allow to reduce interference drag and provide a simple stroke when the side surfaces (21) are swinging parallel to flat slot. The differential operation of the elevator and the rudder can be provided, e.g., by means of a control program in the event of using a direct connection of servo drives to the elevator and the rudder or by any conventional differential mechanism used in aviation, e.g., for hovering ailerons, elevons or V-shaped rudders.

The rear portion of the skin within the elevator and the rudder (57) within the profiled ring and outside (58) thereof preferably comprises concavities on the profile tail for maximizing recovery of static pressure both in the diffuser portion of the ring (at its outlet) and outside. The inner skin (59) is preferably recessed into the ring cross-section to retain the flow when it passes over the slot and reduce the risk of stalling in the diffuser portion. The flow is separated at the toe (55) of the rudder even in the neutral position and enters the outer surface through the slot, thus providing boundary layer blowing and preventing stall on the outer side of the rudder. Due to the convexity of the outer surface of the profiled ring and the offset virtual axis of rotation (51), an increased swing for the toe of the rudder (55) is generated along the chord, which provides aerodynamic balance and flow movement through the slot (56) when turning, thus leading to an increase in the efficiency of the elevator and the rudder; in fact, the rudder operates seemingly like a helmet visor.

A preferred smooth cut of the contour (46) of the rear edge of the profiled ring from below is contemplated, allowing to reduce the washed area of the rear portion of the aircraft, while the upper part of the elevators and the rudders is offset backwards, which is necessary for increasing controllability and stability of the aircraft. Said edge can further comprise deflectable surfaces for changing the diffuser area ratio, providing braking and protection from waves when the amphibious aircraft stops abruptly at a low propeller thrust (in the form of deflectable shields).

The wing (2) of the amphibious aircraft preferably has the shape of a “gull wing” when seen from the front, with the wingtips lowered (inclined) downwards. The wing is divided into two sections: the inner section (27) having a generally positive angle V and the outer section (28) along with the wingtip (26) comprising a strake (30). An aileron (29) or any other roll control device, e.g., an interceptor, is arranged on the outboard wing portion. The section (28) with this wing shape is raised above the water to protect the aileron (29).

The strake (30) serves as a vortex generator, which is especially important for a downwardly inclined wingtip as well as a swept wingtip, since the wingtip of this type is prone to the flow moving along its span which is extremely dangerous, leading to flow detachment and a sharp spin stall. Downwardly inclined wingtips are known in embodiments with leading-edge extensions at the base for forming a vortex, as well as in embodiments using an aerodynamic profile with a large radius of curvature of the leading edge (see, e.g., Geometry modifications of nonplanar wing tip design for adaptation to low speed range, A. Buscher et. al., 25th International congress of the aeronautical sciences), but in this case the solution lies in the lack of a characteristic sharp bend in a transition to a vertical float such that interference drag can be reduced. In this case, the vortex stabilizes the flow above the upper surface of such wingtip; a leading edge with a large radius of curvature also reduces stall risk. A profile with a greater relative thickness compared to the outboard wing portion is achieved naturally due to a shorter chord. The wingtip should preferably have a profile thickness of 17% to 20% and a substantially rectangular shape to increase the volume of displaced water at the contact points during tilt. Moreover, the wingtip may have a broadening portion at the end, e.g., as on the BEDE BD-2 motor glider (where the wingtip performs the function of reducing induced drag and provides increased fuel storage volume). The main advantage of such wingtip is the lack of a sharp bend in the float transition present in conventional amphibious aircraft, thus allowing to reduce interference drag. This wingtip holds the air flow under the wing near the surface well, contributing to the improvement in take-off and landing properties. Furthermore, the use of a downwardly inclined wingtip (with an inverse angle V) improves crosswind resistance. To reduce the risk of submerging the wingtips in the water, it is preferable to arrange the edge of the wingtip slightly above the water when the aircraft is at rest; due to the action of hydrofoils, the fuselage leaves the water faster (compared to schemes with a step), thus preventing submersion. The wingtips predominantly work as a stabilization aid when exposed to wind and asymmetrical loads, and work as a float when moving on water at a low speed.

In general, due to the strakes in front of the wing (8) and the wingtip (30), good anti-spin stall properties and controllability at large angles of attack can be achieved. Moreover, the strake in the transition to the leading edge of the wing (8) allows to maintain the flow above the root of the wing in critical mode so that the rudders (19) and the profiled lateral surfaces of the elevator (21) retain control.

Hydro-ski hydrofoils (24) are attached to the lower portion (23) of the fuselage; they form hydrofoils combining hydro-ski function with a passive stabilization system; the hydrofoils have an inverted V-shape. The V-shape of the hydro-ski hydrofoils, the position and shape of the cutting plates (38), and the load on the hydrofoils are selected so as to achieve the maximum lift-to-drag ratio greater than that of pure hydrofoils. The rear planing skid (36) is arranged at an intermediate distance between the end of the body and the hydro-ski hydrofoils, picked based on optimization of the load thereon and the areas of speed stability for the three-point hydrodynamic configuration.

The hydro-ski hydrofoils comprise working sliding surfaces (42). They are arranged lower compared the fuselage and can have any planing plate shape with modifications: flat, wedge-shaped, with longitudinal steps, etc., to achieve maximum planing efficiency.

The center portion (32) of the fuselage bottom preferably has an increased volume to ensure buoyancy of the front portion of the aircraft and longitudinal stabilization of the aircraft on the water; further, the widened part allows to increase the span of the hydro-ski hydrofoils at set size thereof for better lateral stabilization and an increase in lift-to-drag ratio thereof. The transitional rear portion (33) preferably comprises surfaces concave from the bottom and on the sides for maximum pressure recovery.

The cutouts (43) along the trailing edge on the hydro-ski hydrofoils serve to reduce the area of the inner faces (closest to the fuselage) which, in conjunction with the cutting plates (38) thereon, allows to stabilize the aircraft and avoid lateral submersion of the wing into the water. The outer bends (39) serve to limit the upward and sideward ejection of water, which can lead to the wing flooding with water, and in some modes, to limit the formation of jets which can still fly over the leading edge and enter the air propeller.

Elements (38), (39), (42), (43) form a passive stabilization system for hydro-ski hydrofoils. When the aircraft is tilted (unbalanced), the flow of water across the hydro-ski hydrofoil moves upwards and at a significantly large area, the inner section experiences moments of force which enhance the roll and additionally causes aircraft spin. This process escalates until the aircraft hits water surface with a wingtip and experiences a sharp loss of speed. This occurrence is especially strong in the transition mode to planing when the hydro-ski hydrofoils are still partially submerged in water, and the body and wingtips are already sufficiently out of water and cannot provide lateral stability. This problem is completely eliminated due to cutouts at the root near the trailing edge (43) of the hydro-ski hydrofoil and a bend on the inner surface (38) which can cut off the downward flow; at the same time, the area on the outer sides of the hydro-ski hydrofoils (35) may be insufficient for stabilization due to an intrinsically smaller area because of the chord-to-span ratio (that is, low aspect ratio) than that of the pure hydrofoils used in the Lisa Akoya. For the type of hydrofoil used in the Lisa Akoya amphibious aircraft (inverted U-shape), the depth of the submerged wing appears to have a more significant effect, and as a result, its lifting force increases and equilibrium is restored. This is due to the greater aspect ratio of such a hydrofoil and the smaller influence of the flow along wingspan; however, all disadvantages associated with increased spray formation remain. The embodiment of the solution disclosed in present invention provides extremely smooth planing with minimum splashing and high hydrodynamic lift-to-drag ratio. The cutouts further contribute to shock absorption of hydro-ski hydrofoils in the longitudinal direction, which allows them to adjust to the angle of attack to a certain extent and dampen oscillations when porpoising.

The rear hydrofoil (35) acts as a transom plate to reduce the pitch angle in the transition flight mode and accelerate the transition to the hydrodynamic mode while ensuring the smoothness of said transition (in order to avoid sudden detachment of the rear portion of the body from the water). Excess pitch angle can be caused by the simultaneous action of the hydro-ski hydrofoils and the body (whereas in the step schemes, only the body operates in this mode).

To reduce stall probability in the narrowing portion of the fuselage and, as a result, a reduction in air propeller efficiency, an embodiment with boundary layer suction is contemplated. In this amphibious aircraft, the transition zone (6) between the integrated float (1) and the fuselage (3) can be sensitive to stall due to the diffusion formed there. Due to this boundary layer suction through the slot or perforation (60), it is possible to transfer the widest part of the fuselage further to its end without a stall risk in order to lengthen the laminar flow area. The dimensions of the suction outlets (62, 63, 64) in the underpressure zones are determined based on the optimal ratio between suction loss and the loss associated with stall in specific design cases. The sucked air can pass in the rear portion of the fuselage through cooling radiators of the propulsion apparatus, allowing to supply power thereto and restore pressure loss.

One of the key features of the present invention is the maximized cut-off of water flows from the developed lateral surface of the rear portion of the integrated floats and the profiled ring, which is achieved by means of longitudinal steps (10). Here it is relevant due to the relatively large width of the bottom in the rear portion compared to conventional amphibious aircraft due to the presence of ring empennage. In the absence of such technical solutions, the rear portion of the aircraft body would be stuck to water in the transition to hydrodynamic mode and considerable power would be required to overcome the sticking effect and reduce the wetted surface. This is an especially significant factor in schemes with two lateral submerged floats (catamarans and trimarans). Moreover, this sticking effect can be asymmetrical (due to the roll) and generate significant turning torque. To further cut off the transverse water flows from the bottom (in addition to the longitudinal steps (10) performing the same function in the transition to hydrodynamic mode), plates or longitudinal steps (37) can be mounted on the lower surface of the floats. The latter solution is an especially important factor at the initial stage of acceleration when the body is still deeply immersed in the water. Further, the steps (10) and (37) serve to stabilize the aircraft in the transition to hydrodynamic mode until the three-point configuration becomes operational.

Due to high specific thrust of the propeller in the profiled ring, the increase in air flows over the floats by means of strakes and the wing root, as well as due to effective operation of the hydro-ski hydrofoils, a rapid transition to the hydrodynamic mode is achieved, allowing to achieve improved take-off and landing properties of the aircraft even without high lift devices in the form of flaps, although the mid-set wing scheme allows such devices to be mounted at a sufficient distance from the water.

The aircraft can be provided with landing gear such as three-point landing gear with a front strut, three-point landing gear with a rear strut, four-point landing gear, bicycle landing gear or any other landing gear known in the art. The structure can be formed of metal, composite, wood or any other materials applicable to aviation engineering with corrosion protection in an aqueous environment.

In view of the foregoing, it can be concluded that the essential features of the claimed invention are not known from the prior art and ensure full compliance of the claimed invention with the “novelty” and “inventive step” patentability requirements.

The claimed invention can be used in industry to implement a single-seater or two-seater amphibious aircraft with high efficiency and controllability, and exceptional takeoff and landing properties, mainly used in the field of light aviation. Thus, the claimed invention complies with the “industrial applicability” patentability requirement.

It follows that, in the opinion of the Applicant, the claimed invention fully complies with the patentability requirements under Article 1351 of the Civil Code of the Russian Federation.

1. An amphibious aircraft comprising a fuselage, floats, a wing with wingtips, an empennage, a propulsor, a power plant, a landing gear, main lift hydrofoils and a rear water support, and a water rudder, the aircraft characterized in that the floats are connected to the fuselage, the wing and the empennage in the shape of a profiled ring by means of strakes, fairings, as well as longitudinal steps along the bottom; wherein the propeller-type propulsor is integrated into the profiled ring; wherein the profiled ring comprises a high-set elevator with profiled lateral surfaces, as well as lateral rudders.

2. The aircraft according to claim 1, wherein the main lift hydrofoils are configured for operating in hydro-ski mode.

3. The aircraft according to claim 1, wherein the rear water support comprises a low-set sliding skid and a hydrofoil with the water rudder arranged therebetween.

4. The aircraft according to claim 1, wherein the wing is mid-set.

5. The aircraft according to claim 1, wherein the wingtip is inclined downward and configured to perform the aerodynamic lift function with increased stall resistance, and the float function.

6. The aircraft according to claim 1, wherein the lateral surfaces of the elevator are configured for differential deflection with respect to the central part of the profiled ring, providing a change in the diffuser area ratio of the profiled ring channel.

7. The aircraft according to claim 1, wherein the rudders in the profiled ring are configured for differential deflection, providing a change in the diffuser area ratio of the profiled ring channel.

8. The aircraft according to claim 1, wherein the elevator and the rudder in the profiled ring are slotted.

9. The aircraft according to claim 1, comprising bent plates and cutouts on the root portion of the hydrofoils allowing for passive stabilization of the hydrofoils.

10. The aircraft according to claim 1, comprising bent plates and longitudinal steps on the lower surface of the floats allowing to cut off water flows spreading across the aircraft bottom.

11. The aircraft according to claim 1, comprising hydro-ski having a flattened lower portion and an increased span allowing for takeoff and landing on snow.

12. The aircraft according to claim 1, comprising a smooth cut of the rear contour of the profiled ring in the lower portion thereof allowing to reduce drag.

13. The aircraft according to claim 1, comprising rotary plates integrated into the lower portion of the profiled ring and configured for changing the diffuser area ratio of the ring and protecting the propeller from rear waves.

14. The aircraft according to claim 1, wherein the propeller propulsor thereof comprises a nacelle integrated into the rear portion of the fuselage with smooth fairing transitions.

15. The aircraft according to claim 1, wherein smooth fairing transitions are arranged between the profiled lateral portions of the elevator and the profiled ring.

16. The aircraft according to claim 1, configured for bleeding air through the fuselage tip with integrated radiators for cooling the power plant to provide boundary layer suction in the narrowing area of the fuselage at the rear portion thereof and at the areas of transition to the lateral float.

17. The aircraft according to claim 1, utilizing high lift devices formed by slats and flaps.
